(19) United States
(12) Patent Application Publication
(10) Pub. No.: US 2018/0336749 A1
(43) Pub. Date: Nov. 22, 2018

(54) Intelligent Lock and Use Method Thereof

(71) Applicant: BIO-KEY HONG KONG LIMITED, JIANG MEN CITY (CN)

(72) Inventor: Kwok Fong WONG, Hong Kong (CN)

(21) Appl. No.: 15/665,697

(22) Filed: Aug. 1, 2017

(30) Foreign Application Priority Data
May 19, 2017 (CN) 201710358239.X
May 19, 2017 (CN) 201710359439.7

(51) Int. Cl. G07C 9/00; E05B 17/10

(52) U.S. Cl. CPC G07C 9/00563; E05B 2047/0097; E05B 17/10

(57) ABSTRACT

The invention provides an intelligent lock and use method thereof. The intelligent lock comprises a lock body with a lock hook, an indicating device disposed on the lock body and a control unit provided in the lock body. The use method comprises: receiving a signal that a user presses the lock hook by the control unit; sending a first indication signal via the indicating device by the control unit, when it is determined that the duration of the signal is less than a first preset threshold and the intelligent lock is not registered; and sending a second indication signal via the indicating device by the control unit, when it is determined that the duration is less than a first preset threshold and the intelligent lock is registered. The intelligent lock of the invention has simple structure and easy to operate.

### FIELD OF THE INVENTION

The invention relates to the field of intelligent locks, and more particularly to an intelligent lock and use method thereof.

### DESCRIPTION OF THE RELATED ART

With the development of technology and the needs of people life and production, the intelligent locks are applied more and more widely. Especially in some places such as companies, it is necessary to perform management and authorization operations using fingerprint, and thus the use of intelligent locks is increasingly. The application of the intelligent locks comprises multiple links such as opening, registration and addition, however, the existing intelligent locks has small volume, and it is impossible to achieve multiple functionalities in individual buttons, and thus the intelligent locks having simple structure and easy to operate are urgently needed.

### SUMMARY OF THE INVENTION

In order to solve the above problem of the prior art, the invention provides an intelligent lock and use method thereof to solve the problems in the prior art, for example, a plurality of elements are provided for operation in intelligent locks and the operation is complicated.

In one aspect, the invention provides a use method of an intelligent lock, wherein the intelligent lock comprises a lock body with a lock hook, an indicating device disposed on the lock body and a control unit provided on the lock body. The use method comprises the following steps:

receiving a signal that a user presses the lock hook by the control unit;

sending a first indication signal via the indicating device by the control unit, when it is determined that the duration of the signal is less than a first preset threshold and the intelligent lock is not registered; and

sending a second indication signal via the indicating device by the control unit, when it is determined that the duration is less than a first preset threshold and the intelligent lock is registered.

Preferably, after the first indication signal the intelligent lock enters a registration state, and the method also comprises:

receiving a first fingerprint information input by the user and determining whether the first fingerprint information meets the requirement by the control unit, sending a third indication signal via the indicating device by the control unit when it is determined that the requirement is met, and sending a fourth indication signal via the indicating device by the control unit when it is determined that the requirement is not met;

after the third indication signal, receiving a second fingerprint information input by the user and determining whether the second fingerprint information meets the requirement by the control unit, sending a fifth indication signal via the indicating device by the control unit when it is determined that the requirement is met, and sending the fourth indication signal via the indicating device by the control unit when it is determined that the requirement is not met; and

after the fifth indication signal, receiving a third fingerprint information input by the user and determining whether the third fingerprint information meets the requirement by the control unit, sending a sixth indication signal via the indicating device by the control unit when it is determined that the requirement is met, and sending the fourth indication signal via the indicating device by the control unit when it is determined that the requirement is not met.

Preferably, the step of sending the fourth indication signal via the indicating device by the control unit when it is determined that the requirement is not met comprises:

sending a fourth indication first sub-signal via the indicating device by the control unit when it is determined that a first requirement is not met; and

sending a fourth indication second sub-signal via the indicating device and removing all of the fingerprint information input previously by the control unit when it is determined that a second requirement is not met.

Preferably, the method further comprises:

receiving the signal of pressing the lock hook input by the user by the control unit;

sending a seventh indication signal via the indicating device by the control unit, when it is determined that the duration of the signal is greater than a second preset threshold and the intelligent lock is registered;

after the seventh indication signal, receiving a fourth fingerprint information input by the user and determining whether the fourth fingerprint information is consistent with a pre-stored management fingerprint by the control unit; and

sending a eighth indication signal via the indicating device by the control unit when it is determined that the fourth fingerprint information is consistent with the pre-stored management fingerprint, and the intelligent lock being into a state of adding user fingerprint.

Preferably, the indicating device includes a first color indicator lamp and a second color indicator lamp;

the first indication signal refers to that the first color indicator lamp and the second color indicator lamp slowly flash simultaneously; and

the second indication signal refers to the second color indicator lamp slowly flash simultaneously.

Preferably, both the third indication signal and the fifth indication signal refer to that the first color indicator lamp and the second color indicator lamp slowly flash simultaneously after the second color indicator lamp is on continuously for a first predetermined time; and

the sixth indication signal refers to that the second color indicator lamp is on continuously for a second predetermined time.

Preferably,

the fourth indication first sub-signal refers to that the first color indicator lamp and the second color indicator lamp slowly flash simultaneously after the first color indicator lamp is on continuously for a third predetermined time; and

the fourth indication second sub-signal referring to that the first color indicator lamp and the second color indicator lamp slowly flash simultaneously after the first color indicator lamp is on continuously for a fourth predetermined time.

Preferably, the seventh indication signal refers to the second color indicator lamp quickly flash; and

the eighth indication signal refers to that the first color indicator lamp and the second color indicator lamp slowly flash simultaneously after the second color indicator lamp is on continuously for a fifth predetermined time.

Preferably, the intelligent lock further comprises a power source for power supply and a USB charging interface provided on the lock body;

the control unit detects the power of the power source and sends a charging indication signal when the power of the power source is lower than a preset power.

Preferably, the method also comprises:

receiving a signal that a user presses the lock hook by the control unit;

sending a ninth indication signal via the indicating device by the control unit, when it is determined that the duration is less than a third preset threshold and the intelligent lock is registered;

after the ninth indication signal, receiving the fingerprint input by the user by the control unit;

sending a tenth indication signal via the indicating device and unlocking by the control unit, when it is determined that the finger is consistent with the stored fingerprint; and

sending a eleventh indication signal via the indicating device by the control unit, when it is determined that the finger is not consistent with the stored fingerprint.

Preferably, the method further comprises:

receiving a signal that a user presses the lock hook by the control unit;

sending a twelfth indication signal via the indicating device by the control unit, when it is determined that the duration is greater than a fourth preset threshold and the intelligent lock is registered;

after the twelfth indication signal, receiving the fingerprint input by the user by the control unit;

sending a thirteenth indication signal via the indicating device by the control unit when it is determined that the fingerprint is consistent with the stored management fingerprint;

after the thirteenth indication signal, receiving the signal that the user presses the lock hook and sending a fourteenth indication signal via the indicating device by the control unit, when it is determined that the duration is greater a fourth preset threshold and the intelligent lock is registered;

after the fourteenth indication signal, receiving the fingerprint input by the user, and sending a fifteenth indication signal via the indicating device and removing all of the stored fingerprint by the control unit when it is determined that the fingerprint is consistent with the stored management fingerprint.

Preferably, the ninth indication signal refers to that the second color indicator lamp slowly flash;

the tenth indication signal refers to that the second color indicator lamp is on continuously for a predetermined time; and

the eleventh indication signal refers to that the second color indicator lamp slowly flashes after the first color indicator lamp is on continuously for a predetermined time.

Preferably, the twelfth indication signal refers to that the second color indicator lamp quickly flash;

the thirteenth indication signal referring to that the first color indicator lamp and the second color indicator lamp slowly flash simultaneously after the second color indicator lamp is on continuously for a predetermined time;

the fourteenth indication signal referring to that the first color indicator lamp quickly flash; and

the fifth indication signal referring to that the second color indicator lamp is on continuously for a predetermined time.

In another aspect, the invention also provides an intelligent lock, and the intelligent lock comprises the above lock body with a lock hook, an indicating device disposed on the lock body, a control unit provided on the lock body, a power source for power supply, and a USB charging interface provided on the lock body

### BRIEF DESCRIPTION OF THE DRAWINGS

In order to illustrate more clearly the technical solutions of the embodiments of the invention, the drawings used in the embodiments will be described simply hereinafter. Obviously, the drawings are given by way of example, and for a person skilled in the art, other equivalent drawings can be obtained according to these drawings without any creative work.

FIG. 1 is a schematic view of an intelligent lock according to the invention;

FIG. 2 is a flow chart of registration of the intelligent lock according to the invention;

FIG. 3 is a flow chart of adding a user in the intelligent lock according to the invention;

FIG. 4 is a flow chart of unlocking of the intelligent lock according to the invention;

FIG. 5 is a flow chart of fingerprint elimination of the intelligent lock according to the invention.

### DETAILED DESCRIPTION OF THE INVENTION

In order to make the technical solutions of the invention understood better for the person skilled in the art, the technical solutions of the embodiments of the invention will be described clearly and fully in combination with the drawings of the embodiments, obviously, the described embodiments are merely parts of, instead of all embodiments of the invention. Based on the embodiments of the invention, for a person skilled in the art, all of the other embodiments obtained without any creative work should belong to the protection scope of the invention.

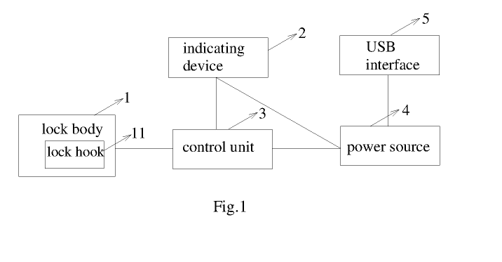

As shown in FIG. 1, an intelligent lock comprises a lock body 1 with a lock hook 11, an indicating device 2 disposed on the lock body and a control unit provided in the lock body.

Preferably, the intelligent lock also comprises a power source 4 for power supply, and a USB charging interface for charging.

The operation of a user is transmitted via devices such as a motor by the lock hook 11 to a control unit 3, and the operation of the user is processed by the control unit 3 in combination with the current state of the intelligent lock. Furthermore, the control unit 3 also is connected with an indicating device 2 to send a signal to the user via the indicating device 2, such that the current state is understood by the user for facilitating the next operation.

Based on the above structure, the use method of the intelligent lock of the application comprises:

Firstly the intelligent lock is opened:

The lock hook is pressed by the user, and a signal of pressing the lock hook is received by the control unit.

The control unit sends a first indication signal via the indicating device, when it is determined that the duration of signal is less than a first preset threshold and the intelligent lock is not registered.

The control unit sends a second indication signal via the indicating device, when it is determined that the duration is less than a first preset threshold and the intelligent lock is registered.

Specifically, if no indication signal is received after the user presses the lock hook, usually it indicates that the intelligent lock is out of power, this moment, charging can be performed via a USB charging interface.

If the intelligent lock is not yet registered, that is, a first indication signal is received by the user, the intelligent lock will get into a registration state, and this means that the intelligent lock could be registered now. In one embodiment of the application, registration is successful until the fingerprint is input correctly for three times, and this process comprises the following steps:

the control unit receives a first fingerprint information input by the user and determines whether the first fingerprint information meets the requirement, when it is determined that the requirement is met the control unit sends a third indication signal via the indicating device, and when it is determined that the requirement is not met the control unit sends a fourth indication signal via the indicating device;

after the third indication signal, the control unit receives a second fingerprint information input by the user and determines whether the second fingerprint information meets the requirement, when it is determined that the requirement is met the control unit sends a fifth indication signal via the indicating device, and when it is determined that the requirement is not met the control unit sends the fourth indication signal via the indicating device;

after the fifth indication signal, the control unit receives a third fingerprint information input by the user and determines whether the third fingerprint information meets the requirement, When it is determined that the requirement is met the control unit sends a sixth indication signal via the indicating device, and when it is determined that the requirement is not met the control unit sends the fourth indication signal via the indicating device.

Thus, a corresponding indication signal will be received once the fingerprint input previously is correct, and the next fingerprint input can be performed, and the registration will be completed until three successful fingerprint input are achieved. A signal indicating incorrect fingerprint input will be received if anyone of the fingerprint input is incorrect. To save the operation, in the present application, when it is determined that there are some small mistakes in the input fingerprint, for example, parts of the fingerprint are ambiguous, the user can input the fingerprint repeatedly, meanwhile, the fingerprint stored previously will not be removed. When it is determined that there are some big mistakes in the input fingerprint, for example, the fingerprint has no overlaps with the fingerprint input previously, the control unit will remove all of the fingerprint stored previously, and transmits a signal to allow the user to restart the fingerprint input program.

The step of sending the fourth indication signal via the indicating device by the control unit when it is determined that the requirement is not met comprises:

the control unit sends a fourth indication first sub-signal via the indicating device when it is determined that a first requirement is not met; and

the control unit sends a fourth indication second sub-signal via the indicating device and removes all of the fingerprint information input previously, when it is determined that a second requirement is not met.

If the above registration is successful, subsequently the addition of fingerprint can be performed, at this time, it is necessary for the user to input the signal of pressing the lock hook such that the management fingerprint authorization is passed. This process comprises the following steps:

the control unit receives a signal of pressing the lock hook input by the user;

the control unit sends a seventh indication signal via the indicating device, when it is determined that the duration of the signal is greater than a second preset threshold and the intelligent lock is registered;

after the seventh indication signal, the control unit receives a fourth fingerprint information input by the user and determines whether the fourth fingerprint information is consistent with a pre-stored management fingerprint; and

the control unit sends an eighth indication signal via the indicating device when it is determined that the fourth fingerprint information is consistent with the pre-stored management fingerprint, and the intelligent lock gets into a status of adding user fingerprint.

In the present application, the fingerprint input at the first two times can be defined as management fingerprint, and the subsequent addition of fingerprint can be performed when it is authorized by the management fingerprint.

Obviously, any signal device can be identified by the user can be used as an indicating device, such as an indicator lamp, an acoustic generator, a display screen or any combination thereof. As we all know, the intelligent lock is small equipment, and a display screen for displaying other information is needed to be provided thereon, thus, the intelligent lock has small space for the indicating device. In this application, for simplifying the structure of the intelligent lock, preferably the indicator lamps with two different colors are used as the indicating device. Hereinafter the red and blue indicator lamps will be illustrated by way of example.

Opening

1.1 The lock hook is pressed shortly, and neither the red indicator lamp nor the blue indicator lamp is on, maybe the battery is out of power, and charging can be performed via a USB port.

1.2 The lock hook is pressed shortly, and the red and blue indicator lamps slowly flash simultaneously to prompt to register the intelligent lock.

1.3 The lock hook is pressed shortly, and the blue indicator lamp slowly flashs and the lock is registered, and user fingerprint can be added.

Registration Process

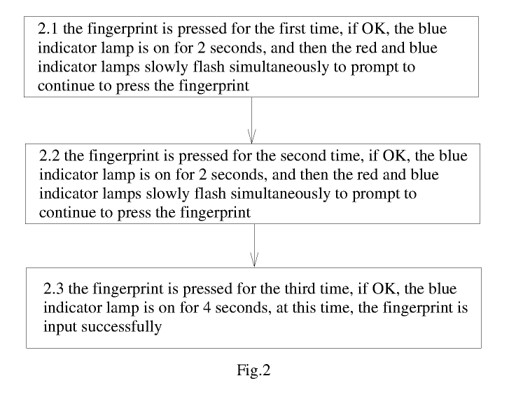

As shown in FIG. 2, the registration process comprises:

2.1 the fingerprint is pressed for the first time, if OK, the blue indicator lamp is on for 2 seconds, and then the red and blue indicator lamps slowly flash simultaneously to prompt to continue to press the fingerprint.

2.2 the fingerprint is pressed for the second time, if OK, the blue indicator lamp is on for 2 seconds, and then the red and blue indicator lamps slowly flash simultaneously to prompt to continue to press the fingerprint.

2.3 the fingerprint is pressed for the third time, if OK, the blue indicator lamp is on for 4 seconds, at this time, the fingerprint is input successfully.

After the fingerprint is input subsequently (2.3), the following two operations can be performed:

a. the lock hook is pressed shortly to exit the state of fingerprint input.

b. registration process is ended when the blue indicator lamp is on for 4 seconds, and if other fingerprint needs to be added, it can be carried out in terms of the process of addition of user fingerprint.

If some mistakes are existing in the steps 2.1, 2.2 and 2.3, there are the following two cases:

a. if there are some small mistakes, the red indicator lamp is on for 2 seconds, then the red and blue indicator lamps slowly flash simultaneously to prompt to continue to press the fingerprint, and the fingerprint data input previously are accumulated.

b. if there are some big mistakes, the red indicator lamp is on for 4 seconds, and then the red and blue lamp slowly flash simultaneously to prompt to continue to press the fingerprint, and all of the fingerprint data of the same finger input previously will be removed.

Addition of User Fingerprint

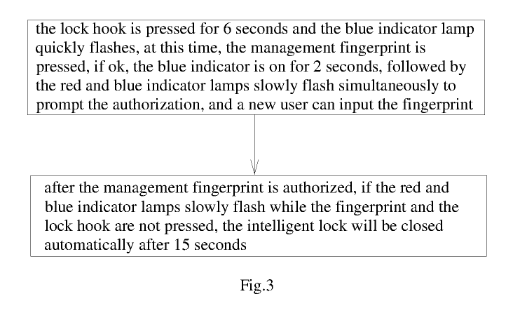

As shown in FIG. 3, the addition of user fingerprint comprises:

3.1 the lock hook is pressed for 6 seconds and the blue indicator lamp quickly flash, at this time, the management fingerprint is pressed, if ok, the blue indicator lamp is on for 2 seconds, followed by the red and blue indicator lamps slowly flash simultaneously to prompt the authorization, and a new user can input the fingerprint, and the steps are the same as 2.1, 2.2 and 2.3.

3.2 after the management fingerprint is authorized, if the red and blue indicator lamps slowly flash while the fingerprint and the lock hook are not pressed, the intelligent lock will be closed automatically after 15 seconds.

It should be noted that, the time and the frequency of flash are set as required in the above embodiments, and the specific values will not affect the technical solutions of the invention.

Of course, the indicator lamps also can be configured as other colors. From the above-mentioned, the indicating device includes the first color indicator lamp and the second color indicator lamp.

The first indication signal refers to that the first color indicator lamp and the second color indicator lamp slowly flash simultaneously, and the second indication signal refers to the second color indicator lamp slowly flash simultaneously.

Both the third indication signal and the fifth indication signal refer to that the first color indicator lamp and the second color indicator lamp slowly flash simultaneously after the second color indicator lamp is on continuously for a first predetermined time.

The sixth indication signal refers to that the second color indicator lamp is on continuously for a second predetermined time.

The fourth indication first sub-signal refers to that the first color indicator lamp and the second color indicator lamp slowly flash simultaneously after the first color indicator lamp is on continuously for a third predetermined time.

The fourth indication second sub-signal refers to that the first color indicator lamp and the second color indicator lamp slowly flash simultaneously after the first color indicator lamp is on continuously for a fourth predetermined time.

The seventh indication signal refers to the second color indicator lamp quickly flash.

The eighth indication signal refers to that the first color indicator lamp and the second color indicator lamp slowly flash simultaneously after the second color indicator lamp is on continuously for a fifth predetermined time.

In the intelligent lock of the invention the structure and operation are simplified, because the operations such as opening, registration and addition of user fingerprint are achieved only by means of two indicator lamps.

All work will not be done if the intelligent lock is out of power, to this end, a detecting unit can be additionally provided in the control unit of the application for detecting the power of the power source, and the detecting unit will send a charging indication signal via the indicating device when it is detected that the power is lower than a preset power. Certainly, the detection and indication action also can be triggered based on the request of the user, or alternatively triggered periodically to reduce the workload of the control unit.

Based on the above structure, the unlocking of the intelligent lock of the application comprises:

the control unit receives a signal that a user presses the lock hook;

the control unit sends a ninth indication signal via the indicating device, when it is determined that the duration is less than a third preset threshold and the intelligent lock is registered;

after the ninth indication signal, the control unit receives the fingerprint input by the user;

the control unit sends a tenth indication signal via the indicating device and unlocking, when it is determined that the finger is consistent with the stored fingerprint; and

the control unit sends a eleventh indication signal via the indicating device, when it is determined that the finger is not consistent with the stored fingerprint.

Preferably, the method also comprises:

the control unit receives a signal that a user presses the lock hook;

the control unit sends a twelfth indication signal via the indicating device, when it is determined that the duration is greater than a fourth preset threshold and the intelligent lock is registered;

after the twelfth indication signal, the control unit receives the fingerprint input by the user;

the control unit sends a thirteenth indication signal via the indicating device, when it is determined that the fingerprint is consistent with the stored management fingerprint;

after the thirteenth indication signal, the control unit receives the signal that the user presses the lock hook, and sends a fourteenth indication signal via the indicating device when it is determined that the duration is greater a fourth preset threshold and the intelligent lock is registered;

after the fourteenth indication signal, the control unit receives the fingerprint input by the user, and the control unit sends a fifteenth indication signal via the indicating device and removes all of the stored fingerprint when it is determined that the fingerprint is consistent with the stored management fingerprint.

Obviously, any signal device can be identified by the user can be used as an indicating device, such as an indicator lamp, an acoustic generator, a display screen or any combination thereof. As we all know, the intelligent lock is small equipment, and a display screen for displaying other informed is needed to be provided thereon, thus, the intelligent lock has small space for the indicating device. In this application, for simplifying the structure of the intelligent lock, preferably the indicator lamps with two different colors are used as indicating device. Hereinafter the red and blue indicator lamps will be illustrated by way of example.

Unlocking

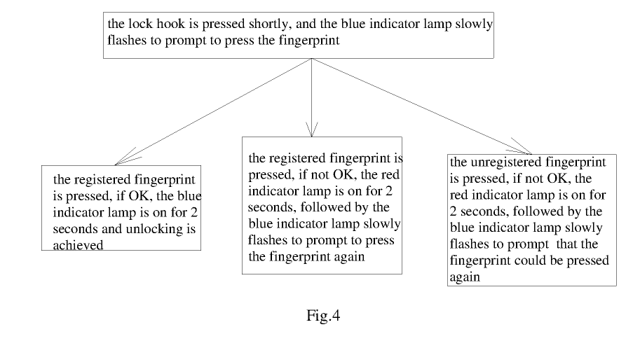

As Shown in FIG. 4, the Process of Unlocking Comprises:

The lock hook is pressed shortly, and the blue indicator lamp slowly flashes to prompt to press the fingerprint.

The registered fingerprint is pressed, if OK, the blue indicator lamp is on for 2 seconds and unlocking is achieved.

The registered fingerprint is pressed, if not OK, the red indicator lamp is on for 2 seconds, followed by the blue indicator lamp slowly flashes to prompt to press the fingerprint again.

The unregistered fingerprint is pressed, if not OK, the red indicator lamp is on for 2 seconds, followed by the blue indicator lamp slowly flashes to prompt that the fingerprint could be pressed again.

Removement of Fingerprint

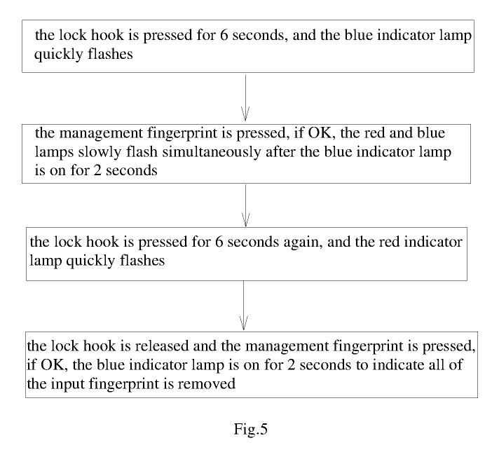

As Shown in FIG. 5, the Process of Fingerprint Removement Comprises:

the lock hook is pressed for 6 seconds, and the blue indicator lamp quickly flashes; the management fingerprint is pressed, if OK, the red and blue lamps slowly flash simultaneously after the blue indicator lamp is on for 2 seconds;

the lock hook is pressed for 6 seconds again, and the red indicator lamp quickly flashes;

the lock hook is released and the management fingerprint is pressed, if OK, the blue indicator lamp is on for 2 seconds to indicate all of the input fingerprint is removed.

Of course, the indicator lamps also can be configured as other colors. From the above-mentioned, the indicating device includes the first color indicator lamp and the second color indicator lamp.

The ninth indication signal refers to that the second color indicator lamp slowly flashes.

The tenth indication signal refers to that the second color indicator lamp is on continuously for a predetermined time.

The eleventh indication signal refers to that the second color indicator lamp slowly flashes after the first color indicator lamp is on continuously for a predetermined time.

The twelfth indication signal refers to that the second color indicator lamp quickly flashes.

The thirteenth indication signal refers to that the first color indicator lamp and the second color indicator lamp slowly flash simultaneously after the second color indicator lamp is on continuously for a predetermined time;

The fourteenth indication signal refers to that the first color indicator lamp quickly flashes.

The fifth indication signal refers to that the second color indicator lamp is on continuously for a predetermined time.

Certainly, the use of the intelligent lock also comprises the processes such as opening, registration and addition of a user.

The specific example is described hereinafter.

Opening

The lock hook is pressed shortly, neither the red indicator lamp nor the blue indicator lamp is not on, maybe the battery is out of power. Charging can be performed via a USB port.

The lock hook is pressed shortly, the red and blue indicator lamps slowly flash simultaneously to prompt to register the intelligent lock.

The lock hook is pressed shortly, the blue indicator lamp slowly flashes and the lock is registered, and user fingerprint can be added.

Registration Process

The registration process comprises:

The fingerprint is pressed for the first time, if OK, the blue indicator lamp is on for 2 seconds, and then the red and blue indicator lamps slowly flash simultaneously to prompt to continue to press the fingerprint.

The fingerprint is pressed for the second time, if OK, the blue indicator lamp is on for 2 seconds, and then the red and blue indicator lamps slowly flash simultaneously to prompt to continue to press the fingerprint.

The fingerprint is pressed for the third time, if OK, the blue indicator lamp is on for 4 seconds, at this time, the fingerprint is input successfully.

After the fingerprint is input successfully, the following two operations can be performed:

a. the lock hook is pressed shortly to exit the state of fingerprint input.

b. registration process is ended when the blue indicator lamp is on for 4 seconds, and if other fingerprint needs to be added, it can be carried out in terms of the process of addition of user fingerprint.

If some mistakes are existing in the above process, there are the following two cases:

a. if there are some small mistakes, the red indicator lamp is on for 2 seconds, then the red and blue indicator lamps slowly flash simultaneously to prompt to continue to press the fingerprint, and the fingerprint data input previously are accumulated.

b. if there are some big mistakes, the red indicator lamp is on for 4 seconds, and then the red and blue lamp slowly flash simultaneously to prompt to continue to press the fingerprint, and all of the fingerprint data of the same finger input previously will be removed.

Addition of User Fingerprint

The lock hook is pressed for 6 seconds and the blue indicator lamp quickly flashes, at this time, the management fingerprint is pressed, if OK, the blue indicator lamp is on for 2 seconds, followed by the red and blue indicator lamps slowly flash simultaneously to prompt the authorization, and a new user can input the fingerprint, and the steps are the same as before.

After the management fingerprint is authorized, if the red and blue indicator lamps slowly while the fingerprint and the lock hook are not pressed, the intelligent lock will be closed automatically after 15 seconds.

It should be noted that, the time and the frequency of flash are set as required in the above embodiments, and the specific values will not affect the technical solutions of the invention.

In the intelligent lock of the invention the structure and operation are simplified, because the operations such as opening, registration and addition of user fingerprint are achieved only by means of two indicator lamps.

The preferred embodiments as above described are given only for illustrating the technical concept and features of the invention, the aim is to make the contents of the invention understood and implemented hereby by one skilled in the art and they should not to be considered limiting of the invention, any equivalent variations or modifications within the spirit and scope of the invention are contained in the extent of protection of the invention.

What is claimed is:

1. A use method of an intelligent lock, the intelligent lock comprising a lock body with a lock hook, an indicating device disposed on the lock body and a control unit provided in the lock body, wherein the method comprises:
receiving a signal that a user presses the lock hook by the control unit;
sending a first indication signal via the indicating device by the control unit, when it is determined that the duration of the signal is less than a first preset threshold and the intelligent lock is not registered; and
sending a second indication signal via the indicating device by the control unit, when it is determined that the duration is less than a first preset threshold and the intelligent lock is registered.

2. The use method as claimed in claim 1, wherein after the first indication signal the intelligent lock enters a registration state, the method also comprises:
receiving a first fingerprint information input by the user and determining whether the first fingerprint information meets the requirement by the control unit, sending a third indication signal via the indicating device by the control unit when it is determined that the requirement is met, and sending a fourth indication signal via the indicating device by the control unit when it is determined that the requirement is not met;
after the third indication signal, receiving a second fingerprint information input by the user and determining whether the second fingerprint information meets the requirement by the control unit, sending a fifth indication signal via the indicating device by the control unit when it is determined that the requirement is met, and sending the fourth indication signal via the indicating device by the control unit when it is determined that the requirement is not met; and
after the fifth indication signal, receiving a third fingerprint information input by the user and determining whether the third fingerprint information meets the requirement by the control unit, sending a sixth indication signal via the indicating device by the control unit when it is determined that the requirement is met, and sending the fourth indication signal via the indicating device by the control unit when it is determined that the requirement is not met.

3. The use method as claimed in claim 2, wherein sending the fourth indication signal via the indicating device by the control unit when it is determined that the requirement is not met comprises:
sending a fourth indication first sub-signal via the indicating device by the control unit when it is determined that a first requirement is not met; and
sending a fourth indication second sub-signal via the indicating device and removing all of the fingerprint information input previously by the control unit when it is determined that a second requirement is not met.

4. The use method as claimed in claim 3, wherein the method further comprises:
receiving the signal of pressing the lock hook input by the user by the control unit;
sending a seventh indication signal via the indicating device by the control unit, when it is determined that the duration of the signal is greater than a second preset threshold and the intelligent lock is registered;
after the seventh indication signal, receiving a fourth fingerprint information input by the user and determining whether the fourth fingerprint information is consistent with a pre-stored management fingerprint by the control unit; and
sending a eighth indication signal via the indicating device by the control unit when it is determined that the fourth fingerprint information is consistent with the pre-stored management fingerprint, and the intelligent lock being into a state of adding user fingerprint.

5. The use method as claimed in claim 4, wherein the indicating device includes a first color indicator lamp and a second color indicator lamp;
the first indication signal referring to that the first color indicator lamp and the second color indicator lamp slowly flash simultaneously; and
the second indication signal referring to the second color indicator lamp slowly flash simultaneously.

6. The use method as claimed in claim 5, wherein
both the third indication signal and the fifth indication signal refer to that the first color indicator lamp and the second color indicator lamp slowly flash simultaneously after the second color indicator lamp is on continuously for a first predetermined time; and
the sixth indication signal referring to that the second color indicator lamp is on continuously for a second predetermined time.

7. The use method as claimed in claim 6, wherein
the fourth indication first sub-signal refers to that the first color indicator lamp and the second color indicator lamp slowly flash simultaneously after the first color indicator lamp is on continuously for a third predetermined time; and
the fourth indication second sub-signal referring to that the first color indicator lamp and the second color indicator lamp slowly flash simultaneously after the first color indicator lamp is on continuously for a fourth predetermined time.

8. The use method as claimed in claim 6, wherein
the seventh indication signal refers to the second color indicator lamp quickly flash; and
the eighth indication signal referring to that the first color indicator lamp and the second color indicator lamp slowly flash simultaneously after the second color indicator lamp is on continuously for a fifth predetermined time.

9. The use method as claimed in claim 1, wherein the intelligent lock further comprises a power source for power supply and a USB charging interface provided on the lock body;
the control unit detecting the power of the power source and sending a charging indication signal when the power of the power source is lower than a preset power.

10. The use method as claimed in claim 5, wherein the method also comprises:
receiving a signal that a user presses the lock hook by the control unit;
sending a ninth indication signal via the indicating device by the control unit, when it is determined that the duration is less than a third preset threshold and the intelligent lock is registered;
after the ninth indication signal, receiving the fingerprint input by the user by the control unit;
sending a tenth indication signal via the indicating device and unlocking by the control unit, when it is determined that the finger is consistent with the stored fingerprint; and
sending a eleventh indication signal via the indicating device by the control unit, when it is determined that the finger is not consistent with the stored fingerprint.

11. The use method as claimed in claim 10, wherein the method further comprises:
receiving a signal that a user presses the lock hook by the control unit;
sending a twelfth indication signal via the indicating device by the control unit, when it is determined that the duration is greater than a fourth preset threshold and the intelligent lock is registered;
after the twelfth indication signal, receiving the fingerprint input by the user by the control unit;
sending a thirteenth indication signal via the indicating device by the control unit when it is determined that the fingerprint is consistent with the stored management fingerprint;
after the thirteenth indication signal, receiving the signal that the user presses the lock hook and sending a fourteenth indication signal via the indicating device by the control unit, when it is determined that the duration is greater a fourth preset threshold and the intelligent lock is registered;
after the fourteenth indication signal, receiving the fingerprint input by the user, and sending a fifteenth indication signal via the indicating device and removing all of the stored fingerprint by the control unit when it is determined that the fingerprint is consistent with the stored management fingerprint.

12. The use method as claimed in claim 11, wherein
the ninth indication signal refers to that the second color indicator lamp slowly flash;
the tenth indication signal referring to that the second color indicator lamp is on continuously for a predetermined time; and
the eleventh indication signal referring to that the second color indicator lamp slowly flashes after the first color indicator lamp is on continuously for a predetermined time.

13. The use method as claimed in claim 12, wherein:
the twelfth indication signal refers to that the second color indicator lamp quickly flash;
the thirteenth indication signal referring to that the first color indicator lamp and the second color indicator lamp slowly flash simultaneously after the second color indicator lamp is on continuously for a predetermined time;
the fourteenth indication signal referring to that the first color indicator lamp quickly flash; and
the fifth indication signal referring to that the second color indicator lamp is on continuously for a predetermined time.

14. An intelligent lock comprising a lock body with a lock hook, an indicating device disposed on the lock body, a control unit provided on the lock body, a power source for power supply, and a USB charging interface provided on the lock body as claimed in claim 9.
